(19) United States
(12) Patent Application Publication
(10) Pub. No.: US 2015/0189504 A1
(43) Pub. Date: Jul. 2, 2015

(54) METHOD AND APPARATUS FOR SECURE HIGH-BANDWIDTH AD-HOC NETWORKING

(71) Applicant: Yen Hsiang Chew, Georgetown (MY)

(72) Inventor: Yen Hsiang Chew, Georgetown (MY)

(21) Appl. No.: 14/141,242

(22) Filed: Dec. 26, 2013

(51) Int. Cl. H04W 12/04; H04W 4/00; H04L 29/06; H04W 76/02

(52) U.S. Cl. CPC H04W 12/04; H04W 76/02; H04W 4/008; H04L 63/0428; H04W 84/18

(57) ABSTRACT

The disclosure generally relates to a method, system and apparatus for establishing a secure ad-hoc network. In one embodiment, the disclosure provides a method for establishing an ad-hoc network by: generating a security key at a first device and communicating the security key to a second device using a first communication channel; selecting a network protocol supported by both the first and the second device; exchanging networking information for establishing a second communication channel using the first communication channel, the second communication channel defining an ad-hoc network; and establishing the second communication channel between the first and the second device using the selected network protocol.

### BACKGROUND

1. Field

The disclosure provides method, system and apparatus for secure, high-bandwidth, ad-hoc networking. Specifically, the disclosure is directed to a secure, high-bandwidth ad-hoc networks between smart computing devices such as Ultrabooks and smartphones.

2. Description of Related Art

Near-field communication (NFC) is a set of standards and protocols for the so-called smart computing devices (e.g., smartphones, Ultrabooks and other NFC-capable devices). NFC protocol enables smart devices to establish radio communication with each other by touching them together, tapping surface of a device, or by bringing the devices within a few inches of each other. Whereas earlier systems such as contactless smart cards were capable of one-way communication, NFC provides two-way communication between endpoints.

In certain smartphones, NFC communication may be established by tapping on the surface of the smartphone. Current and expected applications of NFC include contactless transactions, data exchange and simplified setup of more complex Wi-Fi communication networks.

Using an NFC session to establish some other communication session (e.g., Service Set Identification (SSID)) is supported by the NFC standards. However under certain usage models and circumstances, the alternative communication session established through NFC may be a unique implementation of a wireless standard different from how the standard would have been implemented if the channel was established using conventionally means (e.g., Wi-Fi beacon signal and SSID detection prior to network initialization).

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 illustrates an exemplary wireless environment;

FIG. 2 is another exemplary environment for implementing an embodiment of the disclosure;

FIG. 3 schematically represents one implementation of the disclosure;

FIG. 4 is a flow diagram showing an exemplary method for establishing an ad-hoc communication channel;

FIG. 5 is a flow diagram showing an exemplary method for establishing a secure non-NFC communication channel;

FIG. 6 is an exemplary sequence diagram for establishing a secure ad-hoc network according to one embodiment of the disclosure;

FIG. 7 schematically illustrates an apparatus for implementing an embodiment of the disclosure; and

FIG. 8 is an exemplary system for implementing an ad-hoc network according to one embodiment of the disclosure.

### DETAILED DESCRIPTION

A conventional method for pairing a smart computing device (e.g., Ultrabook) with a smartphone includes several steps. First, the device user must manually set up an ad-hoc network. Conventional systems use a set-up program for this purpose. After the ad-hoc network is established, other devices can join the network if they have the appropriate credentials. The conventional ad-hoc networks revert to the Institute of Electrical and Electronic Engineers (IEEE) standards 802.11 a/c/n, 802.11b or 802.11g to accord network bandwidth. They do so even if the computing device modem can support a higher bandwidth connection (e.g., IEEE 802.11n).

Even though some operating systems provide additional tools to simplify ad-hoc network configuration, the setup and joining processes are still cumbersome and time-consuming. For example, manual setup is required whenever an Ultrabook user pairs itself with a smartphone. In addition, network setup and joining tasks are experientially undesirable and intimidating to less tech savvy users. As stated, the ad-hoc network's Wi-Fi connection automatically switches to a lower bandwidth configuration per IEEE 802.11b or IEEE 802.11g standards. The lower bandwidth limits the effective data transfer between the smart devices.

Another concern is the ad-hoc network's security. The ad-hoc network is less secure because it broadcasts its network SSID periodically. The SSID broadcast can be picked up by potential hackers and used to infiltrate the network. Still another concern with the conventional ad-hoc networks is the lack of automatic data encryption. Additional configuration is needed to add this level of network security.

An embodiment of the disclosure overcomes these and other deficiencies of the conventional ad-hoc networks by establishing a secure, high bandwidth ad-hoc network connection between NFC-capable devices by simply tapping the smartphone on the Ultrabook to establish an NFC interface. The NFC connection is secure and has a higher bandwidth as compared to a conventional non-NFC implementation.

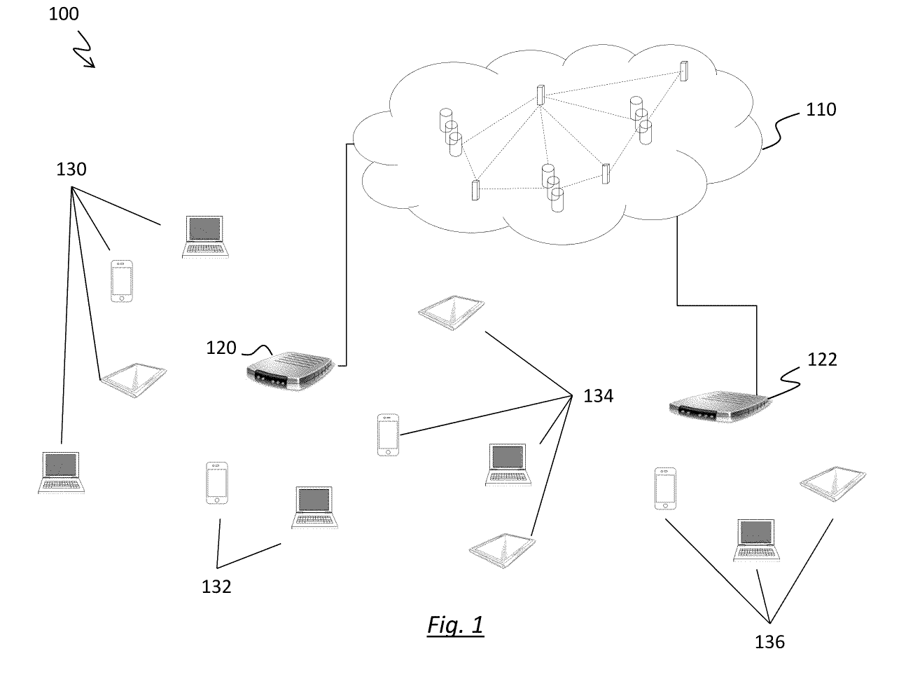

FIG. 1 illustrates an exemplary wireless environment. Specifically, FIG. 1 shows environment 100 having network 110 communicating with access points (APs) 120, 122. Network 110 can define an internet backbone. While FIG. 1 shows APs 120 and 122 as part of network 110, the disclosed principles are not limited thereto and are equally applicable to environments where the AP is outside the network. Exemplary wireless stations (STAs) include smartphones, laptops, Ultrabooks, tablets, embedded computing devices, wearable computing devices or any other wireless NFC-capable device. STAs 130, 132, 134 and 136 can communicate with any of the APs 120, 122. Each of APs 120, 122 can define a different WLAN and may comprise any of a modem, a router, wireless switch, base station or any other circuitry having a processor circuit in communication with a memory circuit adapted to compete for medium and deliver wireless access.

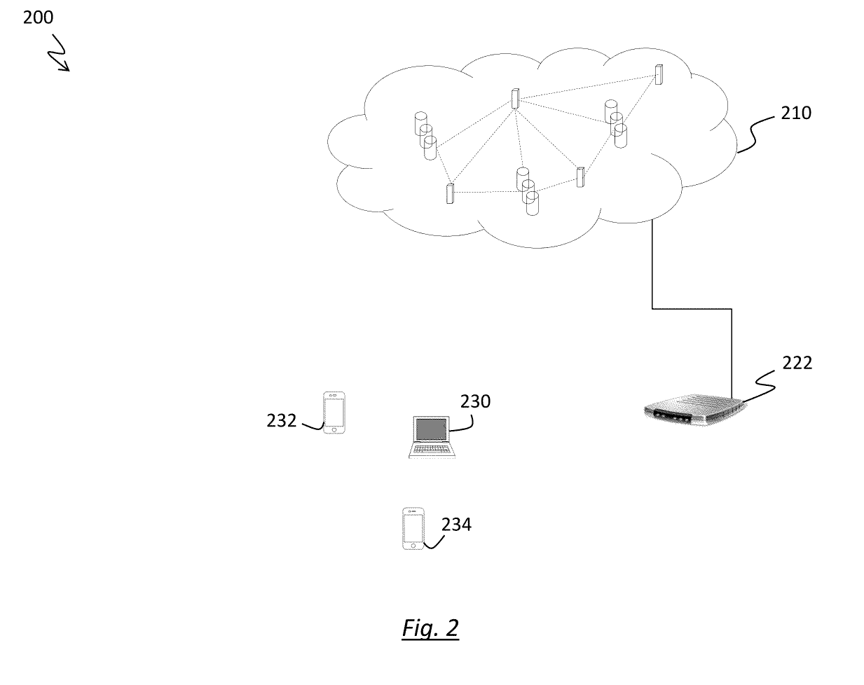

FIG. 2 is another exemplary environment for implementing an embodiment of the disclosure. Environment 200 of FIG. 2 shows internet network 210 having cloud of interconnected servers and databases. Network 210 communicates with AP 222. Wireless devices 230, 232 and 234 may comprise smart devices. For example, wireless device 232 and 234 may define smartphones. Exemplary wireless device 230 may define an Ultrabook configured to execute the NFC protocol. Wireless devices 230, 232 and 234 can communicate with network 210 (thought AP 222) and with each other. The wireless devices may use any conventional communication protocol with AP 222 (e.g., IEEE standard 802.11 a/c/n, IEEE 802.11g, IEEE 802.11n, IEEE 802.11ac, IEEE 802.11ad or any wireless LAN protocol based on IEEE 802.11).

In addition, wireless devices 230, 232 and 234 may communicate with each other through an NFC interface.

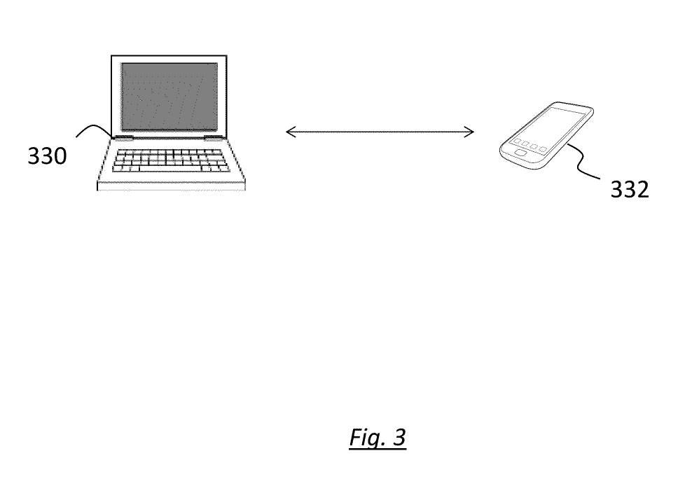

FIG. 3 schematically represents one implementation of the disclosure. In FIG. 3, smart devices 330 (e.g., Ultrabook) and 332 (e.g., smartphone) establish an NFC session (interchangeably, NFC pairing). The pair can exchange additional information during the NFC session to initiate a subsequent ad-hoc network. The pair can use the additional information obtained during the NFC session to uniquely implement a secure, high bandwidth, ad-hoc communications channel.

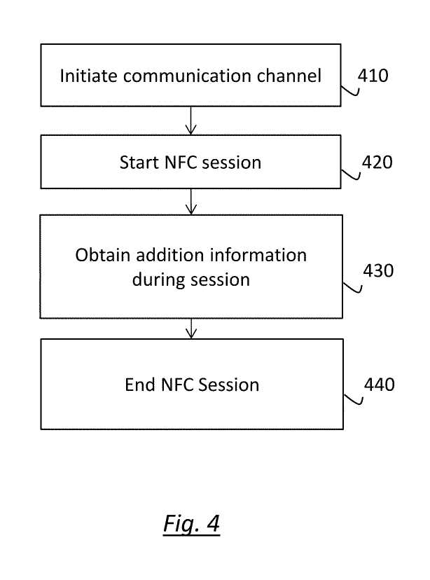

FIG. 4 is a flow diagram showing an exemplary method for establishing an ad-hoc communication channel. Specifically, FIG. 4 shows a method for establishing an ad-hoc communication channel between two smart devices using an NFC protocol. At step 410, the process begins when NFC communication is initiated between the two devices. For example, a first computing device and a second smart device can initiate a communication channel when they are tapped or placed within close proximity.

At step 420 the devices pair and start an NFC session. During the NFC session, the paired devices may exchange information including information relating to an ad-hoc network, modem bandwidth or other security related information.

At step 430, the information exchanged during the NFC session is used to implement an ad-hoc network. The ad-hoc network is not an NFC session and may be a robust wireless session providing higher bandwidth.

At step 440, the 430 NFC session is ended. The NFC session may be ended before the non-NFC session begins. Alternatively, the paired devices may continue the NFC session simultaneously with the Non-NFC session. In one implementation, a first NFC session is used to established a second, non-NFC, session. The second, non-NFC, session is the ad-hoc network pairing which replaces the conventional ad-hoc network discovery and pairing. NFC session may end before or after the non-NFC session begins if the data exchanged during the NFC session is sufficient for both the host and the device to establish a non-NFC session and for peer-to-peer pairing (i.e., smart device to join the non-NFC session) without further network discovery.

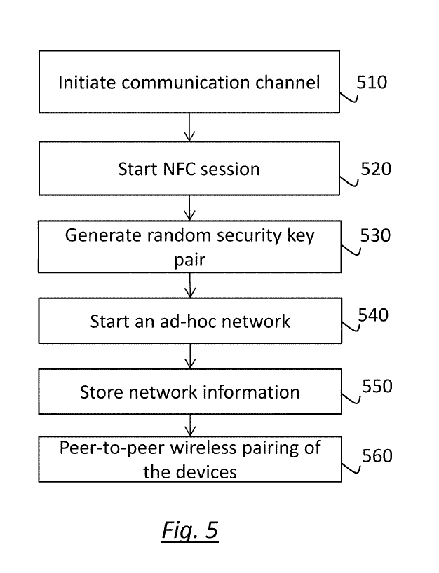

FIG. 5 is a flow diagram showing an exemplary method for establishing a secure an ad-hoc (non-NFC) communication channel according to one embodiment of the disclosure. To start the process, at step 510, the user can tap the smart device (e.g., smartphone) to the NFC interface of a smart computing device (e.g., Ultrabook). The NFC tap invokes the Ultrabook to start an NFC session at step 520. At step 530, the Ultrabook generates a random security key pair and exchanges the key with the smartphone. The security key may be a symmetric or an asymmetric encryption key pair that is generated using a security key generation module of the Ultrabook during the NFC session. Secure key exchange may be performed during the NFC session with or without additional secure key exchange protocol between Ultrabook and smartphone.

In one embodiment, the security key is dynamically generated and sent to each device during their respective NFC sessions so that each device will have a unique encryption key for encrypting its data. For example, device 1 taps and receives Key_A for its secure non-NFC session. Device 2 taps and receives Key_B for its non-NFC session. Data communication for each of device 1 and 2 is encrypted using their respective encryption keys. Advantageously, this method ensures that security key for each device joining the ad-hoc network is unique. In another embodiment, the same security key may be used for all or for a subsets of devices joining the ad-hoc network.

At step 540, the Ultrabook queries smartphone to determine the highest bandwidth wireless protocol (e.g., IEEE 802.11n) the smartphone supports and sets up an ad-hoc network based on the results of the query. The Ultrabook then sends network information to the smartphone. Network information may include an SSID for the ad-hoc network, log in credentials and other network parameters. Once received, the smartphone can join the ad-hoc network using the network information received at the NFC session. Subsequent data communication between the smartphone and the Ultrabook on the ad-hoc network may be encrypted for further security measure using the security key exchanged between Ultrabook and smartphone during the NFC session. Because the security key was dynamically generated and securely exchanged during an NFC pairing between the Ultrabook and the smartphone, other wireless devices will not be able to access data communicated between these devices on the ad-hoc network.

At step 550 the security keys as well as the ad-hoc network information is stored at the smartphone as well as the smart computing device. At step 560, secure pairing between the computing device and the smartphone may be performed immediately through peer-to-peer Wi-Fi pairing using the stored security keys and network information. Pairing may also be established at a later time using the security keys and network information stored in both devices. The exemplary embodiment of FIG. 5 is less susceptible to network hacking as the computing device may randomly generate the security key and communicates it to the smartphone through the private NFC session.

The ad-hoc network will be secure because hackers will not have access to the security key exchanged during the NFC session. The security key may be randomly generated. In this manner, the ad-hoc network becomes virtually a private ad-hoc network. The peer-to-peer network will be secure for additional reasons. First, network information is discovered and exchanged using a private NFC pairing session between the Ultrabook and the smartphone and not by conventional means of network discovery through a wireless medium. Certain subsets of network information required for identifying the existence of an ad-hoc network prior to joining (e.g., SSID, supported rates, capability information, etc.) may be hidden. For example, certain information may be removed or randomized from broadcast beacon frames, as they are no longer needed to enable the smartphone to join the ad-hoc network if the smartphone can obtain the same information via the NFC session. Accordingly, there is less information for a nearby hacker to identify the ad-hoc network and hack the network using remote hacking methods.

Second, if an ad-hoc network is configured to join a smartphone only via NFC pairing, then there is no way for a nearby hacker to gain access to the network using a remote hacking method. For example, a remote hacking method may include positioning a hacking device few meters from the Ultrabook. The hacker may try to hack the ad-hoc network by first discovering the ad-hoc network and then tricking the Ultrabook that it is joining the ad-hoc network as an authorized device. These steps may be performed a few meters away, out of the Ultrabook user's observation range. With NFC pairing, the hacker will have to be physically close to the Ultrabook (within the observation range of Ultrabook user) in order to join its device to the Ultrabook's ad-hoc network.

The ad-hoc network may have a higher bandwidth than if devised using conventional methods. This is because conventional ad-hoc networks revert to an IEEE 802.11 b/g bandwidth even though the smartphone or the smart computing devices may be capable of supporting an IEEE 802.11n bandwidth.

Once the network credentials are established and the security key is exchanged, other smartphones supporting the same wireless protocol (e.g., IEEE 802.11n) as the first device may be invited to the ad-hoc network through subsequent NFC sessions. In another embodiment, a new security key pair may be generated and transferred to the second device. The new security key may be used to encrypt any data communication between the Ultrabook and the second device. Hence, each smartphone may use the same or a different security key to encrypt their respective data communication with the Ultrabook. This configuration is useful for unique 1:1 pairing and for establishing multiple secure virtual channels for data communication between Ultrabook and smartphones.

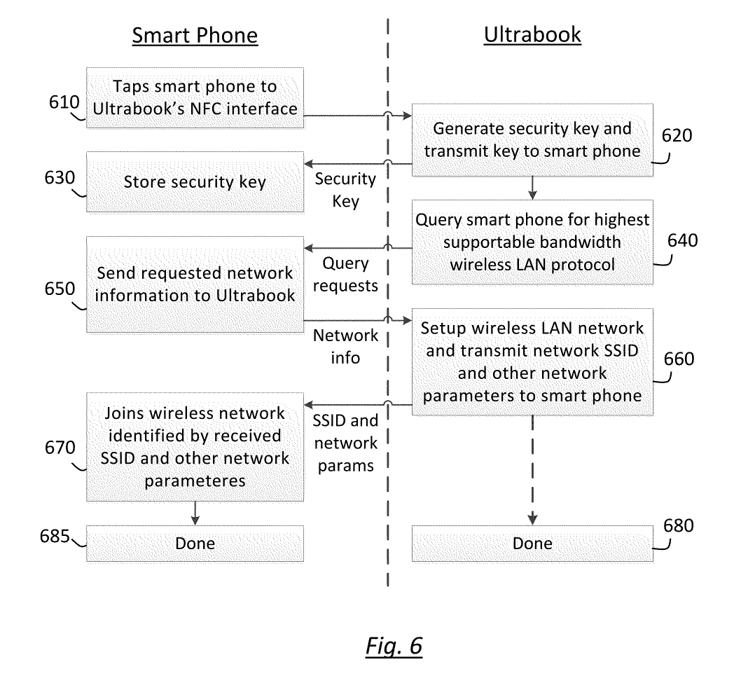

FIG. 6 is an exemplary sequence diagram for establishing a secure ad-hoc network according to one embodiment of the disclosure. While the exemplary embodiment of FIG. 6 shows network pairing between a smartphone and an Ultrabook, the disclosed principles are not limited thereto and can be extended to all NFC-compatible devices.

The process starts at step 610 by tapping the smartphone to start Ultrabook's NFC interface. At step 620, the Ultrabook generates a security key and transmits the key to the smartphone. At step 630, the smartphone stores the security key. The Ultrabook also stores the security key for future use. The Ultrabook may include hardware, software, firmware or a system on chip for generating the security key. For example, a key generation hardware can generate an encryption key (symmetric or asymmetric) and securely transfer the security key to the smartphone through the NFC interface.

At step 640, the Ultrabook queries the smartphone to determine the highest supportable bandwidth wireless LAN protocol. Smartphones and Ultrabooks typically include modems capable of supporting much higher bandwidth than the bandwidth configuration of IEEE 802.11 a/c/n standard. The smartphone replies to the Ultrabook's inquiry and sends requested network information to the Ultrabook at step 650.

At step 660, the Ultrabook configures and sets up an ad-hoc network. The Ultrabook also sends the network's SSID and other network parameters to the smart phone via the NFC interface. The additional network parameters may include, network name, SSID, MAC address, signaling method, channel information, data rate, transmission frequency band and other login security information.

At step 670, the smartphone joins the network identified by the SSID. In an exemplary embodiment, the Ultrabook or smartphone may be prompted to enter a password or other login information before joining the ad-hoc network. In another embodiment, a password is not required. Instead, the Ultrabook may query a smartphone's MAC address or perform other authentication measures prior to accepting the smartphone's NFC request to join a network. In still another embodiment, a password may not be necessary because tapping a smart phone to an Ultrabook can only be established at close proximity and may be sufficiently secure. The processes end at steps 680 and 685.

A second smartphone (or a subsequent smart device) may also join the secure ad-hoc network at a later time through similar NFC tap on the Ultrabook NFC interface. Hence, it can be seen that a potential hacker will not know the existence of the ad-hoc network by SSID snooping. In addition, data packet transfer between the Ultrabook and the smartphone may be encrypted using the security key generated by the Ultrabook and transferred to smartphone through the NFC tap. The security key may also be generated by the smartphone and communicated to another smartphone or an Ultrabook through an NFC interface.

In still another embodiment, a higher bandwidth ad-hoc network may be established through a special implementation of the IEEE 802.11n network protocol. Here, during the tap one or both devices (Ultrabook and smartphone) determine the highest supportable data bandwidth of each device (e.g., IEEE 802.11n). If both devices support IEEE 802.11n then an IEEE 802.11n network configuration is setup by the Ultrabook. Thereafter, the smartphone joins the ad-hoc network using the IEEE 802.11n bandwidth communication protocol.

The disclosed embodiments are applicable to future versions of the IEEE 802.11 protocol that may supersede IEEE 802.11n as the highest bandwidth or more advanced versions of the protocol. For example, if a future protocol (e.g., IEEE 802.11xyz) is supported, smart devices can use the disclosed embodiments to establish and join the ad-hoc network using the new protocol.

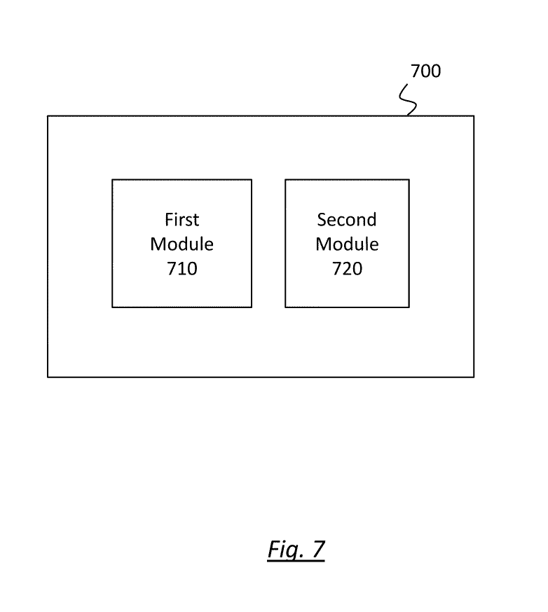

FIG. 7 schematically illustrates an apparatus for implementing an embodiment of the disclosure. Specifically, FIG. 7 shows device 700 which can be an integral part of a larger system or can be a stand-alone unit in a smart device. For example, device 700 may comprise hardware, software, firmware, system on chip or any combination thereof. Device 700 may also be part of a larger system having multiple antennas, a radio and a memory system. Device 700 includes first module 710 and second module 720. Each of module 710 and 720 can define one or more independent processor and/or memory circuits. In an exemplary embodiment, at least one of modules 710 or 720 includes a processor circuit and a memory circuit communicating with each other. In another embodiment, the modules 710 and 720 define different parts of the same data processing circuit. While shown with two modules, device 700 may have multiple modules or a single module without departing from the disclosed principles.

First module 710 can be configured to establish an NFC session with another smart device once activated. Module 710 may also generate a security key and communicate the security key to the corresponding smart device. Module 710 may additionally set up an ad-hoc network and communicate the network's identification information to the corresponding smart device. Finally, first module 710 can communicate the information to second module 720 and store (or have the second module store) the information for future reference. After establishing the ad-hoc network, second module 720 can authenticate the corresponding smart device into the network. The authentication process may include verifying the security key, network address, password, device identity information stored inside a secure element of the device (e.g., a SIM card) or any other authentication information communicated between the corresponding devices.

Device 700 significantly simplifies and improves the ad-hoc network set up and management. First, secure ad-hoc network setup and pairing between the smart devices can be automatically established through an NFC tap without requiring manual or user initiated system configuration and network initiation. Second, the network information and SSID (e.g., subsets of network information and SSID in beacon frames) are not periodically broadcasted as in the conventional wireless networks. Instead, the smart device obtains network information and SSID through an NFC tap. Third, the wireless ad-hoc network may be established using a higher bandwidth communication protocol (e.g., IEEE 802.11n) and is not limited to a lower transmission speed of the conventional ad-hoc Wi-Fi networks. Finally, data packet transmitted between the smart devices may be encrypted using a dynamically generated security key which can be transferred to the smart device during NFC tap network pairing. Configuring the ad-hoc network to be only joinable via NFC tap prevents a hacker from gaining access to the network using a remote hacking method without being physically close to the ad-hoc network host device.

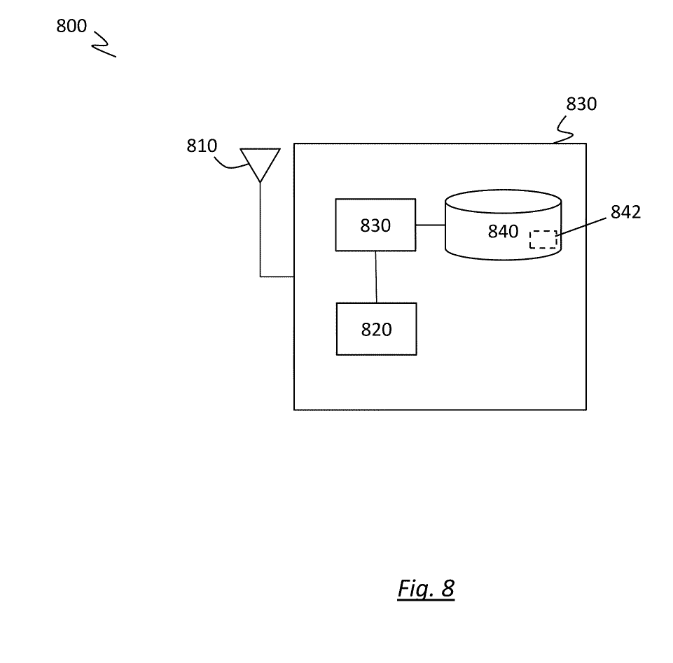

FIG. 8 is an exemplary system for implementing an ad-hoc network according to one embodiment of the disclosure. For example, the steps of any of the above-disclosed flow diagrams may be implemented in the system of FIG. 8. System 800 of FIG. 8 may define a smart device such as an Ultrabook or a smartphone. While system 800 is shown with antenna 810, the disclosure is not limited to having one antenna. Multiple antennas can be added to system 800 such that different signals for different protocols can be received at different antennas. The signal(s) received at antenna 810 are relayed to radio 820. Radio 820 may include transceiver components such as front-end receiver components or a receiver/transmitter. Although not shown, system 800 may be connected to a WLAN or the internet backbone.

Radio 820 may convert analog signals to a digital data stream and direct the data stream to processor 830. Processor 830 may include one or more modules as discussed in relation to FIG. 7. Processor 830 also communicates with memory circuit 840. While shown as a separate circuitry in the exemplary system of FIG. 8, it should be noted that instructions 842 can be embedded on processor 830 as firmware to obviate the addition of memory circuit 840.

Memory circuit 840 may contain instructions 842 for processor 830 to implement one or more of the steps of the exemplary methods disclosed herein. Memory circuit 840 may define a non-transitory computer readable medium containing a set of instructions to processor 830 to perform a process comprising: (1) generating a security key at a first device and communicating the security key to a second device using a near-field communication (NFC) session between the first and the second device; and (2) authenticating the second device into the secure ad-hoc network using the security key. Instructions 842 may be programmed directly on processor 830 to obviate memory circuit 840.

While the principles of the disclosure have been illustrated in relation to the exemplary embodiments shown herein, the principles of the disclosure are not limited thereto and include any modification, variation or permutation thereof.

What is claimed is:

1. A method for establishing a secure ad-hoc network, comprising:
generating a security key at a first device and communicating the security key to a second device using a first communication channel;
selecting a network protocol supported by both the first and the second device;
exchanging networking information for establishing a second communication channel using the first communication channel, the second communication channel defining an ad-hoc network; and
establishing the second communication channel between the first and the second device using the selected network protocol.

2. The method of claim 1, further comprising storing the network information including the security key at one of the first device or the second device.

3. The method of claim 2, further comprising encrypting data communication on the second channel using the security key.

4. The method of claim 1, further comprising querying the second device for a plurality of supportable network protocols using the first communication channel.

5. The method of claim 1, further comprising authenticating the second device by the first device using the first communication channel before joining the second device to the second communication channel.

6. The method of claim 1, wherein the first communication channel defines a near-field communication (NFC) session between the first device and the second device.

7. The method of claim 6, further comprising excluding the exchanged network information from a plurality of beacon messages for the second communication channel.

8. The method of claim 1, further comprising configuring the second communication channel to be joinable only through the first communication channel.

9. A communication device comprising:
a first module configured to generate a security key at a first device and communicating the security key to a second device using a first communication channel, the first module further configured to select a network protocol supported by both the first and the second device; and
a second module configured to exchange networking information for establishing a second communication channel using the first communication channel and establish the second communication channel using the selected network protocol.

10. The device of claim 9, wherein the second communication channel define a secure ad-hoc network.

11. The device of claim 9, wherein one of the first or the second module is further configured to store the network information including the security key.

12. The device of claim 9, wherein one of the first or the second modules is further configured to encrypt data communication on the second channel using the security key.

13. The device of claim 9, wherein one of the first or the second module is further configured to query the second device for a plurality of supportable network protocols using the first communication channel.

14. The device of claim 9, wherein one of the first or the second module is further configured to authenticate the second device using the first communication channel before joining the second device to the second communication channel.

15. The device of claim 9, wherein the first communication channel defines a near-field communication (NFC) session.

16. A system comprising:
an antenna to transmit a signal;
a radio to communicate with the antenna; and
a processor to communicate with the radio, the processor configured to
generate a security key at a first device and communicating the security key to a second device using a first communication channel,
select a network protocol supported by both the first and the second device,
exchange networking information for establishing a second communication channel using the first communication channel, and
establish the second communication channel using the selected network protocol.

17. The system of claim 16, wherein the second communication channel defines a secure ad-hoc network and wherein the first communication channel defines and NFC-session.

18. The system of claim 16, wherein the processor is further configured to store the network information including the security key.

19. The system of claim 16, wherein the processor is further configured to encrypt data communication on the second channel using the security key.

20. The system of claim 16, wherein the processor is further configured to query the second device for a plurality of supportable network protocols using the first communication channel.

21. The system of claim 16, wherein the processor is further configured to authenticate the second device using the first communication channel before joining the second device to the second communication channel.

22. A computer-readable storage device containing a set of instructions to cause a computer to perform a process comprising:
generate a security key at a first device and communicating the security key to a second device using a first communication channel;
select a network protocol supported by both the first and the second device;
exchange networking information for establishing a second communication channel using the first communication channel, the second communication channel defining an ad-hoc network; and
establish the second communication channel between the first and the second device using the selected network protocol.

23. The computer-readable storage device of claim 22, wherein the instructions further cause the computer to store the network information including the security key at one of the first device or the second device.

24. The computer-readable storage device of claim 22, wherein the instructions further cause the computer to query the second device for a plurality of supportable network protocols using the first communication channel.

25. The computer-readable storage device of claim 22, wherein the instructions further cause the computer to establish a first communication comprising a near-field communication (NFC) session between the first device and the second device.
